(19) United States
(12) Patent Application Publication
(10) Pub. No.: US 2026/0267058 A1
(43) Pub. Date: Sep. 10, 2026

(54) ULTRA LIGHT line of special optical cables is designed to provide remote control of highly maneuverable and tactical highly mobile robot, UGV, UAV and others drone systems (Provisional Application #63/563,701 - 03/11/2024)

(71) Applicant: Ruslan Prysiazhnyi, Orlando, FL (US)

(72) Inventor: Ruslan Prysiazhnyi, Orlando, FL (US)

(21) Appl. No.: 19/075,540

(22) Filed: Mar. 10, 2025

(51) Int. Cl. G02B 6/02; G02B 6/44

(52) U.S. Cl. CPC G02B 6/02395; G02B 6/4427; G02B 6/4436

(57) ABSTRACT

The invention relates to a flexible, lightweight, and durable tactical fiber-optic cable for use in unmanned mobile systems. The cable includes non-metallic components, aramid reinforcement, and LSZH sheathing, suitable for field deployment, resistant to harsh environments, and optimized for secure high-speed data transmission.

The invention provides a special fiber-optic cable that provides increased flexibility, strength and lightness to ensure reliable remote control of a mobile robot or drone of any type.

This is about fiber optic cables with single-mode (SMF) and multimode (MOF) optical fibres designed for control systems for airborne and ground mobile objects, including high-speed, including for the organisation of safe and secure communication networks resistant to electromagnetic effects, in medium and severe environmental conditions.

### 2. CROSS-REFERENCE TO RELATED APPLICATIONS

This application claims the benefit of U.S. Provisional Application No. 63/563,701, filed Mar. 11, 2024.

### 3. STATEMENT REGARDING FEDERALLY SPONSORED RESEARCH OR DEVELOPMENT

Not applicable.

### 4. NAMES OF THE PARTIES TO A JOINT RESEARCH AGREEMENT

Not applicable.

### 5. BACKGROUND OF THE INVENTION

The present invention relates to tactical fiber-optic cables for remote control of unmanned mobile systems, such as UAVs, UGVs, and drones. Existing solutions are often heavy, inflexible, or vulnerable to environmental and electromagnetic effects. There is a need for a lightweight, durable, and flexible solution that enables secure high-speed data transmission in field conditions.

### 6. BRIEF SUMMARY OF THE INVENTION

The invention provides a special fiber-optic cable construction that offers increased flexibility, durability, and electromagnetic immunity. The design uses aramid yarn reinforcement, non-metallic LSZH sheathing, and microbend-resistant optical fibers. This allows for compact, reelable deployment in harsh environments and compatibility with standard tactical systems.

This type of fiber optic cable is used primarily for remote control of a mobile robot, drone or UAV of any type. These cables are also intended for use in the following applications:
Tethered drone cables;
Ground tactical fiber optic cable;
Field deployable tactical fiber optic cable;
Tactical fiber optic cable assemblies;
Fiber Optic Cables for Aerospace Applications;
Reinforced aerospace fiber optic cable.

These cables are designed with specific features to meet the demanding requirements of UAV and UGV applications:
High flexibility and crush resistance;
Lightweight and compact design;
Ability to withstand harsh environments;
Easy deployment and retrieval capabilities.

Both UAV and UGV tactical fiber cables are used in military communications, surveillance, reconnaissance, and other applications requiring secure and high-speed data transmission in challenging conditions, and for Aerospace Applications.

### 7. BRIEF DESCRIPTION OF THE DRAWINGS

FIG. 1 illustrates a cross-sectional view of the FLY cable configuration. FIG. 2 shows the layered structure of the COMBO cable. FIG. 3 depicts the enhanced TERRA variant. FIG. 4 shows the production process schematic.

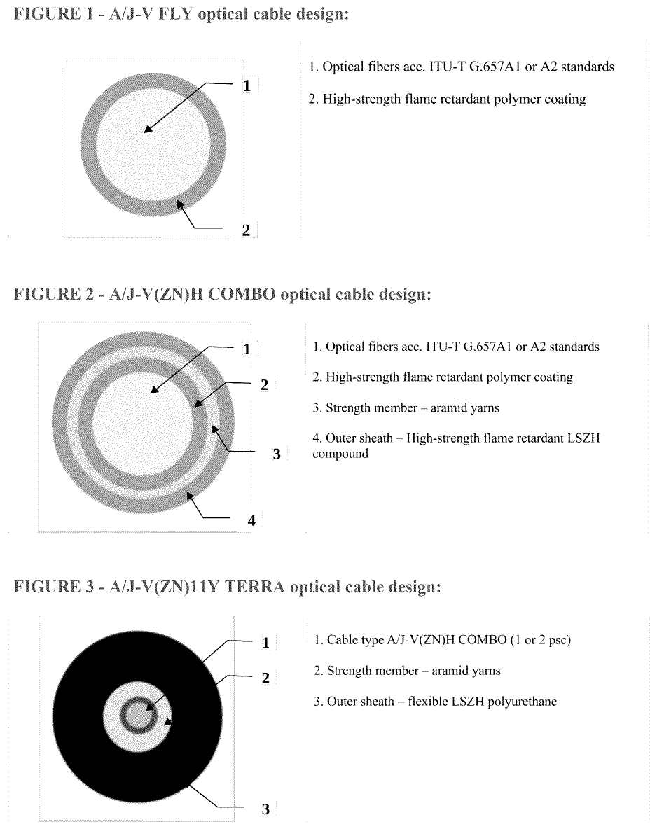

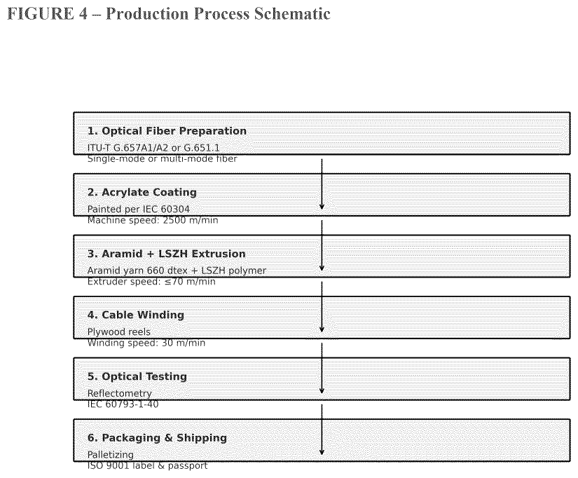

### 8. DETAILED DESCRIPTION OF THE INVENTION

This invention compares favorably with existing solutions in terms of its physical parameters of flexibility, durability and reliability of communication in difficult conditions of use, as well as low cost and ease of manufacture.

The invention provides a special fiber-optic cable that provides increased flexibility, strength and lightness to ensure reliable remote control of a mobile robot or drone of any type. Its production technology is described below.

This is about fiber optic cables with single-mode (SMF) and multimode (MOF) optical fibres designed for control systems for airborne and ground mobile objects, including high-speed, including for the organisation of safe and secure communication networks resistant to electromagnetic effects, in medium and severe environmental conditions.

These cables have been tested in extreme operating conditions under critical loads, and exceptional reliability of construction and communication has been confirmed.

The ULTRA LIGHT range of optical cables is designed to organize direct control for highly manoeuvrable and highly mobile tactical unmanned aerial and ground systems.

### 8.1. A/J-V FLY Optical Cable

### Key Advantages:

The cable's outer diameter of 350 nm or 600 nm provides exceptional compactness and ease of use. The different diameters of the cable can be achieved by using different polymer coating or coating with different radial thickness.
The use of fibre resistant to microbending allows the cable to be used in places where the cable is required to be more flexible;
Possibility of cable termination;
The use of high-strength flame retardant polymer coating as a protective layer allows the cable to be used in conditions of increased mechanical loads while meeting the requirements for non-proliferation of combustion;
Absence of metal elements provides protection against electromagnetic impulses.

### 8.2. A/J-V(ZN)H COMBO Optical Cable

### Key Advantages:

The cable's outer diameter of 600 nm or 900 nm provides exceptional compactness and ease of use. The different diameters of the cable can be achieved by using the aramid yarns (110 or 220 dtex) with different mechanical performance in order to have optimal compactness/mechanical strength ratio.
Possibility of cable termination;
The use of high-strength fire-resistant polymer coating as a protective layer, as well as high-modulus aramid yarns, allows the cable to be used in conditions of increased mechanical loads while meeting the requirements for non-proliferation of combustion;
Absence of metal elements provides protection against electromagnetic impulses.

### 8.3. COMBO-Tactic Optical Cable

This is an even more stronger version of the COMBO cable, which adds a combination of coating layers #2 to the COMBO model (see the previous figure), using several layers with different parameters, varnish and aramid yarns (combined technology).

### 8.4. A/J-V(ZN)11Y TERRA Optical Cable

### Key Advantages:

The cable's 2.0 mm outer diameter makes the cable compact and easy to work with in the field;
Possibility to terminate the cable outer sheath with standard types of connectors;
Outer sheath material—halogen-free low-smoke polyurethane, resistant to external influences, non-propagating combustion.

### 9. PRODUCTION TECHNOLOGY

### 9.1. For the Production of 1 km of the Cable the Following Materials are Required

1.012 km of singlemode or multimode optical fiberes (type ITU-T G.657A1, G.657A2 or G.651.1; depending on customer's requirements);
0.015 kg of acrylate paint for fibres;
0.115 kg of high-density aramid yarns 660 dTex;
1.05 kg of high-strength flame retardant LSZH compound.

### 9.2. Manufacturing Process Includes the Following Stages:

1) Optical Fiber Preparation.
2) On the painting machines coat the fibre with acrylate painting with the velocity 2500 meters/min in acc. with IEC 60304 colour coding system;
3) On the extrusion line type SCL-I (extruder #30 or 40 max) make the sheath by paying-off fine filaments of aramid yarns 660 dtex altogether with coated fibre and extrusion of non-flammable low smoke zero-halogen (LSZH) polymer (colour is in accordance with customer's specification). Velocity of extrusion should be no more than 70 meters/min;
4) On the winding machine rewind the cable with the velocity 30 meters/min on to reels and cut it for the standard lengths of 25 and 40 km.
5) Make acceptance of the cable by checking its optical characteristics on reflectometer;
6) Package the reels on standard pallet, and ship the cable to the customer.

Manufacturing process-Sketch Map (Technological Mode)-are submitted in a separate files:
A_J-V_FLY_technological processing_v.1.0_eng.docx
A_J-V_COMBO_technological processing_v.1.0.docx
A_J-V_TERRA_technological processing_v.1.0.docx

### 10. GENERAL TECHNICAL REQUIREMENTS

are submitted in a separate file:
ULTRA LIGHT_technical description_full_v1.2_0325.docx

1. A lightweight and flexible tactical fiber-optic cable for remote control of unmanned mobile systems, comprising: one or more optical fibers compliant with ITU-T G.657A1, G.657A2 or G.651.1 standards; a high-strength flame-retardant polymer coating surrounding said optical fibers; a strength member comprising high-density aramid yarns (e.g. 660 dtex) applied concentrically; an outer sheath formed of halogen-free, low-smoke polymer compound (LSZH); wherein the cable is compact, crush-resistant, non-metallic, and configured to provide high reliability and electromagnetic immunity under field conditions.

2. A method for manufacturing a tactical fiber-optic cable, the method comprising: providing one or more optical fibers compliant with ITU-T G.657A1, G.657A2 or G.651.1 standards; coating the fibers with acrylate paint per IEC 60304 using painting machines operating at approximately 2500 meters per minute; applying high-density aramid yarns (e.g. 660 dtex) as strength members around the coated fibers; extruding a flame-retardant, low-smoke halogen-free (LSZH) polymer sheath over the aramid yarns using an extrusion line operating at speeds no greater than 70 meters per minute; winding the finished cable onto reels at a rate of 30 meters per minute into standard lengths; testing the cable's optical performance using a reflectometer; and
packaging the cable reels on standard pallets for shipment; wherein the method produces a cable optimized for mechanical durability, electromagnetic resistance, and compact tactical deployment.
